(19) United States
(12) Patent Application Publication
(10) Pub. No.: US 2025/0270766 A1
(43) Pub. Date: Aug. 28, 2025

(54) GAS BARRIER LAMINATE

(71) Applicants: Dow Global Technologies LLC, Midland, MI (US); Rohm and Haas Company, Collegeville, PA (US)

(72) Inventors: Qiangqiang Yan, Zhejiang (CN); Xiaomei Song, Shanghai (CN); Yafei He, Shanghai (CN); Hongyu Chen, Shanghai (CN); Brian R. Einsla, Collegeville, PA (US); Ray E. Drumright, Midland, MI (US); Xiangyi Zhang, Phoenixville, PA (US)

(21) Appl. No.: 18/702,949

(22) PCT Filed: Dec. 7, 2021
(86) PCT No.: PCT/CN2021/136058

§ 371 Date: Apr. 19, 2024

(51) Int. Cl. D21H 19/22; B65D 65/42; C09D 129/04; D21H 19/82; D21H 21/14; D21H 27/10

(52) U.S. Cl. CPC D21H 19/22; B65D 65/42; C09D 129/04; D21H 19/82; D21H 21/14; D21H 27/10; B65D 2565/387

(57) ABSTRACT

A gas barrier laminate and a process for preparing the gas barrier laminate. comprising: (i) providing a paper substrate, (ii) applying an aqueous gas barrier composition to the paper substrate, and (iii) drying the aqueous gas barrier composition at a temperature of less than 120° C. for less than 10 minutes to form a gas barrier coating; thereby obtaining the gas barrier laminate; where the aqueous gas barrier composition comprises: (a) an ethylene-vinyl alcohol copolymer having a saponification degree of 85 mol % or more, and (b) a partially neutralized (meth) acrylic acid polymer having a degree of neutralization of from 6 mol % to 18 mol %; where the weight ratio of the ethylene-vinyl alcohol copolymer to the partially neutralized (meth) acrylic acid polymer is in a range of from 80:20 to 50:50.

### FIELD

The present invention is a gas barrier laminate and a process for preparing the same.

### INTRODUCTION

Metallized films (i.e., plastics containing a thin layer of aluminum metal) are widely used in the food packaging industry and can achieve necessary gas barrier properties. As metallization accounts for most of the energy that is consumed in the packaging manufacturing process, it is a need for scalable solutions that can replace or eliminate metallized films without compromising gas barrier properties.

Efforts have been made to replace metal layer coated on plastic substrates by water-soluble polymers for food packaging, such as polyvinyl alcohol (PVOH), polyacrylic acid (PAA) or partially neutralized PAA, due to their good gas barrier properties against oxygen in dry state. However, the gas barrier properties of PVOH and/or PAA films greatly depend on humidity and significantly deteriorate under high humidity conditions, i.e., 50% relative humidity (RH) or even higher. There are challenges for improving gas barrier properties under high humidity while maintaining processability including, for example, simple manufacturing steps and mild processing conditions. For example, incorporation of sufficient amounts of nanofillers (e.g., >10% by weight relative to polymer weight) to PVOH may reach a desired gas barrier property under high humidity, but have difficulties in homogeneously dispersing of these nanofillers in the PVOH matrix, which usually leads to severe aggregation, deterioration of mechanical properties, and/or cracking during processing or folding into desired shapes. Another approach is heat treatment and/or biaxial stretching of PVOH and/or PAA films coated on polyolefin or polyester film substrate at high temperatures (e.g., 150-200 degree Celsius (° C.)), which makes processing complex and energy-consuming.

It is more challenging to prepare gas barrier packaging based on paper substrates, due to more limitations on improving gas barrier properties under high humidity and processing. It is desirable for paper packaging to achieve an oxygen transmission rate (OTR) of 1.0 cubic centimeter per square meter per day (cc/m²·day) or less as determined according to ASTM D3985-05 using a MOCON Ox-Tran Model 2/21 at 23° C. and 50% RH. More importantly, foldability is a critical property for food packaging, which enables the packaging to be formed into desired shapes without significantly compromising properties such as gas barrier properties against oxygen, particularly during transportation.

It is desirable to discover a gas barrier laminate comprising a paper substrate that can achieve the required low OTR as well as good foldability while can be produced with easy processability.

### SUMMARY

The present invention solves the problem of discovering a process for preparing a gas barrier laminate comprising a paper substrate without the aforementioned problems. The gas barrier laminate is particularly suitable for food packaging applications.

The gas barrier laminate of the present invention is excellent in gas barrier property against oxygen as indicated by an oxygen transmission rate (OTR) of 1.0 ce/m²·day or less. At the same time, the gas barrier laminate has good foldability as indicated by a folded OTR (i.e., OTR after folding) of 4.5 cc/m²·day or less. The OTR and folded OTR were measured according to ASTM D3985-05 using a MOCON Ox-Tran Model 2/21 at 23° C. and 50% RH (further details provided below in the Examples section). The gas barrier laminate can be produced by the process of the present invention with easy and quick processability while still offering the above excellent gas barrier and foldability properties.

In a first aspect, the present invention relates to a process for preparing a gas barrier laminate. The process comprises:
(i) providing a paper substrate,
(ii) applying an aqueous gas barrier composition to the paper substrate, wherein the aqueous gas barrier composition comprises:
(a) an ethylene-vinyl alcohol copolymer having a saponification degree of 85 mol % or more, and
(b) a partially neutralized (meth)acrylic acid polymer having a degree of neutralization of from 6 mol % to 18 mol %:

wherein the weight ratio of the ethylene-vinyl alcohol copolymer to the partially neutralized (meth)acrylic acid polymer is in a range of from 80:20 to 50:50; and (iii) drying the aqueous gas barrier composition at a temperature of less than 120° C. for less than 10 minutes to form a gas barrier coating; thereby obtaining the gas barrier laminate.

In a second aspect, the present invention relates to a gas barrier laminate comprising a paper substrate and a gas barrier coating residing on the paper substrate, wherein the gas barrier coating is formed from an aqueous gas barrier composition comprising:
(a) an ethylene-vinyl alcohol copolymer having a saponification degree of 85 mol % or more, and
(b) a partially neutralized (meth)acrylic acid polymer having a degree of neutralization of from 6 mol % to 18 mol %;
wherein the weight ratio of the ethylene-vinyl alcohol copolymer to the partially neutralized (meth)acrylic acid polymer is in a range of from 80:20 to 50:50.

In a third aspect, the present invention relates to a food packaging comprising the gas barrier laminate of the second aspect.

### DETAILED DESCRIPTION

Test methods refer to the most recent test method as of the priority date of this document when a date is not indicated with the test method number. References to test methods contain both a reference to the testing society and the test method number. The following test method abbreviations and identifiers apply herein: ASTM refers to ASTM International methods; ISO refers to International Organization for Standards; and JIS refers to Japanese Industrial Standard.

Products identified by their tradename refer to the compositions available under those tradenames on the priority date of this document.

“And/or” means “and, or as an alternative”. All ranges include endpoints unless otherwise indicated. Unless otherwise stated, all weight-percent (wt %) values are relative to polymer weight.

The word fragment “(meth)acryl” refers to both “methacryl” and “acryl”. For example, (meth)acrylic acid refers to both methacrylic acid and acrylic acid, and methyl (meth)acry late refers to both methyl methacrylate and methyl acrylate.

“Structural units”, also known as “polymerized units”, of the named monomer, refers to the remnant of the monomer after polymerization, that is, polymerized monomer or the monomer in polymerized form. For example, a structural unit of methyl methacrylate is as illustrated:

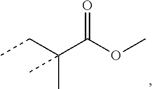

where the dotted lines represent the points of attachment of the structural unit to the polymer backbone.

The gas barrier laminate of the present invention comprises a paper substrate and a gas barrier coating on the paper substrate. The gas barrier coating is formed from an aqueous gas barrier composition. The gas barrier coating is a dried gas barrier composition, that is, a layer of the aqueous gas barrier composition which has been dried.

The aqueous gas barrier composition useful in the present invention comprises one or more partially neutralized (meth)acrylic acid polymers. “(Meth)acrylic acid polymer” refers to a homopolymer of acrylic acid, methacrylic acid, salts thereof, or mixtures thereof; a copolymer of acrylic acid, methacrylic acid, salts thereof, or mixtures thereof, with one or more comonomers that are other than acrylic acid, methacrylic acid, and the salts thereof, or mixtures thereof.

The (meth)acrylic acid polymer useful in the present invention is typically a water-soluble polymer, preferably present in the form an aqueous solution. The (meth)acrylic acid polymer may comprise structural units of (meth)acrylic acid such as methacrylic acid and acrylic acid, salts thereof, or mixtures thereof; at a concentration of from 50 w1% to 100 wt %, and can be 50 wt % or more, 55 wt % or more, 60 wt % or more, 65 wt % or more, 70 wt % or more, 75 wt % or more, or even 80 wt % or more, while at the same time is generally 100 wt % or less, and can be 99 wt % or less, 95 wt % or less, 92 wt % or less, 90 wt % or less, 88 wt % or less, 85 wt % or less, or even 80 wt % or less, based on the weight of the (meth)acrylic acid polymer. Desirably, the (meth)acrylic acid polymer is a polyacrylic acid homopolymer. The (meth)acrylic acid polymer may consist of structural units of methacrylic acid, and/or structural units of acrylic acid. For example, the (meth)acrylic acid polymer consists of 30 wt % to 70 wt % of structural units of acrylic acid and from 70 wt % to 30 wt % of structural units of methacrylic acid, based on the weight of the (meth)acrylic acid polymer.

The (meth)acrylic acid polymer useful in the present invention may comprise or be free of structural units of one or more additional ethylenically unsaturated acid monomers other than the (meth)acrylic acid. Examples of suitable additional ethylenically unsaturated acids include maleic acid, crotonic acid, itaconic acid, fumaric acid, monomethyl itaconate, monomethyl fumarate, monobutyl fumarate, 2-acrylamido-2-methylpropane sulfonic acid, vinyl sulfonic acid, styrene sulfonic acid, 1-allyloxy-2-hydroxypropane sulfonic acid, alkyl allyl sulfosuceinic acid, sulfoethyl (meth)acrylate; phosphoalkyl (meth)acrylates such as phosphoethyl (meth)acrylate, phosphopropyl (meth)acrylate, and phosphobutyl (meth)acrylate, phosphoalkyl crotonates, phosphoalkyl maleates, phosphoalkyl fumarates, phosphodialkyl (meth)acrylates, phosphodialkyl crotonates, and allyl phosphate; or a monomer bearing an acid-forming group which yields or is subsequently convertible to, such an acid group, such as anhydride, (meth)acrylic anhydride, or maleic anhydride; or mixtures thereof. The (meth)acrylic acid polymer may comprise structural units of the additional ethylenically unsaturated acid at a concentration of zero to less than 50 wt %, and can be zero or more, 0.1 wt % or more, 0.5 wt % or more, 0.8 wt % or more, 1.0 wt % or more, 1.2 wt % or more, 1.5 wt % or more, 1.8 wt % or more, or even 2 wt % or more, while at the same time is generally less than 50 wt %, and can be 40 wt % or less, 30 wt % or less, 20 wt % or less, 10 wt % or less, or even 5 wt % or less, based on the weight of the (meth)acrylic acid polymer.

The (meth)acrylic acid polymer useful in the present invention may comprise or be free of structural units of one or more ethylenically unsaturated nonionic monomers “Nonionic monomer” herein refers to a monomer that does not bear an ionic charge between pH=1-14. Examples of suitable ethylenically unsaturated nonionic monomers include (meth)acrylamide, alkyl esters of (meth)acrylic acid such as butyl (meth)acrylate, vinyl aromatic monomers such as styrene, acrylonitrile, ethylene, propylene, butylene, or mixtures thereof. The (meth)acrylic acid polymer may comprise structural units of the ethylenically unsaturated nonionic monomer at a concentration of zero to less than 50 wt %, and can be zero or more, 0.1 wt % or more, 0.5 wt % or more, 1 wt % or more, 1.5 wt % or more, or even 2 w1% or more, while at the same time is generally less than 50 wt %, and can be 40 wt % or less, 30 wt % or less, 20 wt % or less, 10 wt % or less, or even 5 wt % or less, based on the weight of the (meth)acrylic acid polymer.

Desirably, the (meth)acrylic acid polymer comprises structural units of monomers selected from acrylic acid, methacrylic acid, maleic acid, maleic anhydride, methacryl amide, acryl amide, or mixtures thereof. More preferably, the (meth)acrylic acid polymer is selected from polyacrylic acids: polymethacrylic acids; copolymers of acrylic acid and methacrylic acid; copolymers of (a) (meth)acrylic acid, (b) maleic acid and/or maleic anhydride, and optionally (c) (meth)acryl amide; or mixtures thereof. Suitable commercially available (meth)acrylic acid polymers may include, for example, ACUSOL™ 402 polyacrylic acids and ACUMER™ 1510 polyacrylic acids both available from The Dow Chemical Company (ACUSOL and ACUMER are trademarks of The Dow Chemical Company).

The (meth)acrylic acid polymer useful in the present invention may have a weight average molecular weight (Mw) of 1,500 grams per mole (g/mol) or more, and can be 1,800 g/mol or more, 2,000 g/mol or more, 3,000 g/mol or more, 4,000 g/mol or more, 5,000 g/mol or more, 8,000 g/mol or more, 10,000 g/mol or more, 12,000 g/mol or more, 15,000 g/mol or more, 18,000 g/mol or more, or even 20,000 g/mol or more, while at the same time is generally 400,000 g/mol or less, and can be 300,000 g/mol or less, 200,000 g/mol or less, 100,000 g/mol or less, 90,000 g/mol or less, 80,000 g/mol or less, 70,000 g/mol or less, 60,000 g/mol or less, 50,000 g/mol or less, 40,000 g/mol or less, 30,000 g/mol or less, 25,000 g/mol or less, 24,000 g/mol or less, 23,000 g/mol or less, 22,000 g/mol or less, or even 21,000 g/mol or less. Molecular weight of the (meth)acrylic acid polymer can be measured by gel permeation chromatography (GPC) (further details provided below under GPC Analysis for (Meth)acrylic Acid Polymer).

The partially neutralized (meth)acrylic acid polymer useful in the present invention can be obtained by partially neutralizing the carboxyl groups of the (meth)acrylic acid polymer with one or more bases. Examples of suitable bases include ammonia: alkali metal or alkaline earth metal compounds such as sodium hydroxide, potassium hydroxide, lithium hydroxide, calcium hydroxide, calcium oxide, sodium carbonate, aluminum hydroxide, zinc oxide, or mixtures thereof: ethanolamine: diethylaminocthylamine: or mixtures thereof. The partially neutralized (meth)acrylic acid polymer can be obtained by admixing the base with an aqueous solution of the (meth)acrylic acid polymer. The degree of neutralization of the partially (meth)acrylic acid polymer can be achieved by controlling the quantitative ratio of the (meth)acrylic acid polymer to the base.

The partially neutralized (meth)acrylic acid polymer useful in the present invention may have a degree of neutralization of 6 mole-percent (mol %) or more, and can be 7 mol % or more, 8 mol % or more, 9 mol % or more, or even 10 mol % or more, while at the same time is generally 18 mol % or less, and can be 17 mol % or less, 16 mol % or less, 15 mol % or less, 14 mol % or less, 13 mol % or less, 12 mol % or less, or even 11 mol % or less. The degree of neutralization can be determined by the equation (I) below:

Degree of neutralization=(1−X/Y)×100% (I)
wherein X stands for a total mole number of the carboxyl groups per gram in the partially neutralized (meth)acrylic acid polymer and Y stands for a total mole number of carboxyl groups per gram in the (meth)acrylic acid polymer before the partial neutralization.

The aqueous gas barrier composition useful in the present invention comprises one or more ethylene-vinyl alcohol copolymers. The ethylene-vinyl alcohol copolymer is typically a water soluble polymer. The ethylene-vinyl alcohol copolymer is usually obtained by saponification of an ethylene-vinyl acetate copolymer. The ethylene-vinyl alcohol copolymer may have a saponification degree (also as “degree of hydrolysis”) of 85 mol % or more, and can be 88% or more, 90 mol % or more, 92 mol % or more, 94 mol % or more, 95 mol % or more, and can be more than 95 mol %, or even 96 mol % or more, while at the same time generally has a saponification degree of 99.9 mol % or less, and can be 99.7 mol % or less, 99.5 mol % or less, 99 mol % or less, 98.5 mol % or less, or even 98 mol % or less. The saponification degree can be determined according to JIS K 6726:1994 Testing methods for polyvinyl alcohol (further details provided below under Measurement of SaponificationDegree of EVOH).

The ethylene-vinyl alcohol copolymer useful in the present invention may have an ethylene content of 1.0 mol % or more, and can be 1.5 mol % or more, 1.8 mol % or more, 2.0 mol % or more, 2.1 mol % or more, 2.2 mol % or more, 2.4 mol % or more, 2.5 mol % or more, 2.8 mol % or more, or even 3.0 mol % or more, while at the same time generally has an ethylene content of 10 mol % or less, and can be 9.0 mol % or less, 8.0 mol % or less, 7.0 mol % or less, 6 mol % or less, 5 mol % or less, 4.8 mol % or less, 4.5 mol % or less, 4.2 mol % or less, 4.0 mol % or less, 3.5 mol % or less, 3.2 mol % or less, or even 3.0 mol % or less. Ethylene content can be determined by nuclear magnetic resonance (NMR) analysis. Suitable commercially available ethylene-vinyl alcohol copolymers may include those under trademarks such as EXCEVAL available from Kuraray Company (Japan).

The ethylene-vinyl alcohol copolymer useful in the present invention may have a weight average molecular weight of 10,000 g/mol or more, and can be 20,000 g/mol or more, 30,000 g/mol or more, 40,000 g/mol or more, 50,000 g/mol or more, 60,000 g/mol or more, or even 70,000 g/mol or more, while at the same time is generally 300,000 g/mol or less, and can be 280,000 g/mol or less, 250.000 g/mol or less, 220,000 g/mol or less, 200,000 g/mol or less, 180,000 g/mol or less, 150,000 g/mol or less, 120,000 g/mol or less, 100,000 g/mol or less, or even 80,000 g/mol or less. Molecular weight of the ethylene-vinyl alcohol copolymer can be determined according to JIS K 6726:1994 (further details provided below under Measurement of Molecular Weight of EVOH).

The weight ratio of the ethylene-vinyl alcohol copolymer to the partially neutralized (meth)acrylic acid polymer in the aqueous gas barrier composition may be in a range of from 80:20 to 50:50, and can be 78:22 or less, 75:25 or less, 72:28 or less, 70:30 or less, 68:32 or less, 65:35 or less, 62:38 or less, or even 60:40 or less, while at the same time is 50:50 or more, 52:48 or more, 55:45 or more, 58:42 or more, or even 60:40 or more. Desirably, the weight ratio of the ethylene-vinyl alcohol copolymer to the neutralized (meth)acrylic acid polymer is in a range of from 75:25 to 55:45. When aqueous dispersions or solutions of the neutralized (meth)acrylic acid polymer and/or ethylene-vinyl alcohol copolymer are used, the weight ratio berein refers to the weight ratio by solids weight (or by dry weight). The solids weight herein can be calculated by (dispersion or solution weight) * (solids content of the dispersion or solution).

The aqueous gas barrier composition useful in the present invention may comprise or be free of one or more defoamers. “Defoamer” herein refer to a chemical additive that reduces and hinders the formation of foam. Defoamers may be silicone-based defoamers, mineral oil-based defoamers, ethylene oxide/propylene oxide-based defoamers, alkyl polyacrylates and mixtures thereof. Suitable commercially available defoamers may include, for example, TEGO Airex 901 W, TEGO Airex 902 W and TEGO Foamex 1488 polyether siloxane copolymer emulsions available from TEGO, BYK-022 and BYK-024 silicone deformer available from BYK, and mixtures thereof. The defoamer may be present at a concentration of from zero to 0.5 wt %, from 0.01 wt % to 0.4 wt %, or from 0.02 wt % to 0.2 wt %, based on the total weight of the partially neutralized (meth)acrylic acid polymer and ethylene-vinyl alcohol copolymer.

The aqueous gas barrier composition useful in the present invention may comprise or be free of one or more pigments. “Pigment” herein refers to an inorganic or organic material which is practically insoluble in the medium in which it is incorporated. Examples of suitable pigments include mica, layered double hydroxides (LDH), montmorillonite, bentonite, laponite, kaolinite, saponite, vermiculite, zeolite, silicate, tale, kaolin, clay, calcium carbonate, or mixtures thereof. The pigment may be present at a concentration of from zero to 80 wt %, and can be zero or more, 0.1 w1% or more, 1 wt % or more, 5 wt % or more, or even 10 wt % or less, while at the same time is generally 80 wt % or less, and can be 70% wt% or less, 60 wt % or less, 50 wt % or less, 40 wt % or less, 30 wt % or less, 20 w1% or less, 15 wt % or less, or even 12 wt % or less, based on the total weight of the partially neutralized (meth)acrylic acid polymer and ethylene-vinyl alcohol copolymer.

The aqueous gas barrier composition useful in the present invention may comprise or be free of one or more thickeners, also known as “rheology modifiers”. Thickeners may include polyvinyl alcohol (PVA), urethane associate thickeners (UAT), polyether urea polyurethanes (PEUPU), polyether polyurethanes (PEPU), or mixtures thereof. Examples of suitable thickeners include alkali swellable emulsions (ASE) such as sodium or ammonium neutralized acrylic acid polymers: hydrophobically modified alkali swellable emulsions (HASE) such as hydrophobically modified acrylic acid copolymers: associative thickeners such as hydrophobically modified ethoxylated urethanes (HEUR); and cellulosic thickeners such as methyl cellulose ethers, hydroxymethyl cellulose (HMC), hydroxyethyl cellulose (HEC), hydrophobically-modified hydroxy ethyl cellulose (HMHEC), sodium carboxymethyl cellulose (SCMC), sodium carboxymethyl 2-hydroxyethyl cellulose, 2-hydroxypropyl methyl cellulose, 2-hydroxyethyl methyl cellulose, 2-hydroxybutyl methyl cellulose, 2-hydroxyethyl ethyl cellulose, and 2-hydoxypropyl cellulose. The thickener may be present at a concentration of from zero to 1.0 wt %, and can be zero or more, 0.05 wt % or more, or even 0.01 wt % or more, while at the same time is generally at a concentration of 1.0 wt % or less, and can be 0.5 wt % or less, or even 0.2 wt % or less, based on the total weight of the partially neutralized (meth)acrylic acid polymer and ethylene-vinyl alcohol copolymer.

The aqueous gas barrier composition useful in the present invention may comprise or be free of one or more crosslinkers. Suitable crosslinkers may include, for example, hydrolyzed styrene-maleic anhydride (SMA) polymers such as ammonia-hydrolyzed SMA polymers, ethylene-maleic anhydride polymer, zirconium alkoxides, titanium alkoxides, silanes such as vinyltrimethoxysilane (VTMS), glutaraldebyde, glyoxal, imide, boric acid, cinnamaldehyde (CIN), or mixtures thereof. The crosslinker may be present at a concentration of from zero to 10 wt %, and can be zero or more, 0 1 wt % or more, 0.5 wt % or more, or even 1.0 wt % or more, while at the same time is generally 10 wt % or less, and can be 8 wt % or less, 6 wt % or less, 5 wt % or less, or even 2 wt % or less, based on the total weight of the ethylene-vinyl alcohol copolymer and partially neutralized (meth)acrylic acid polymer

The aqueous gas barrier composition useful in the present invention can further comprise or be free of any one or any combination of more than one of the following additional components: anti-block agents, wetting agents, colorants, optical brighteners, dispersants, and preservatives. The total concentration for these additional components can be in a range of from zero to 0.5 wt %, from 0.01 wt % to 0.2 wt %, or from 0.02 wt % to 0.15 wt %, based on the total weight of the partially neutralized (meth)acrylic acid polymer and ethylene-vinyl alcohol copolymer.

The aqueous gas barrier composition useful in the present invention can be in the form of an aqueous solution or aqueous dispersion. “Aqueous” dispersion or solution herein means that particles dispersed or dissolved in an aqueous medium. By “aqueous medium” herein is meant water and from zero to 30 wt %, based on the weight of the medium, of water-miscible compound(s) such as, for example, alcohols, glycols, glycol ethers, glycol esters, or mixtures thereof. Such aqueous dispersion or solution may have a solids content of from 5 wt % to 50 wt %, and can be 5 wt % or more, 10 wt % or more, or even 15 wt % or more, while at the same time is generally 50 wt % or less, and can be 45 wt % or less, 40 w1% or less, 35 wt % or less, 30 wt % or less, or even 25 wt % or less, based on the weight of the aqueous dispersion or solution (i.e., the aqueous gas barrier composition). The solids content of the aqueous gas barrier composition is selected to afford desired viscosities, for example, ranging from 200 to 2.000 centipoises (cP), and can be 200 cP or more, 400 cP or more, 600 eP or more, or even 1,000 cP or more, while at the same time is generally 2,000 cP or less, and can be 1,800 cP or less, 1,500 cP or less, 1,200 cP or less, or even 1,000 cP or less, as determined using a Brookfield Ametek DV2TLVTJO (LV #3,100 revolutions per minutes (RPM)) at room temperature (23+2 degrees Celsius (° C.)). Upon drying under certain conditions described below, the aqueous gas barrier composition forms the gas barrier coating. Generally, the thickness of the gas barrier coating may vary depending on the weight of the paper substrate, for example, the gas barrier coating may have a dry weight less than 15%, and can be 12% or less, or even 10% or less, of the weight of the paper substrate. The thickness of the gas barrier coating may be in a range of from I micrometer (μm) to 20 μm, and can be I μm or more, 2 μm or more, 3 μm or more, 4 μm or more, 5 μm or more, 8 μm or more, or even 10 μm or more, while at the same time is generally 20 μm or less, and can be 18 μm or less, 15 μm or less, 13 μm or less, or even 12 μm or less.

The gas barrier laminate of the present invention further comprises the paper substrate that comprises opposing primary surfaces A “primary surface” is a surface having a planar surface area equal to the largest planar surface area of any surface of an article. Opposing primary surfaces refers to a primary surface of an article and a surface opposing the primary surface, the surface opposing the primary surface generally also being a primary surface. Planar surface area refers to the area of a surface as projected onto a plane so as to neglect surface area contributions due to contour features (for example, peaks and valleys) in the surface. The gas barrier coating can be on one primary surface or both primary surfaces, of the paper substrate. For example, the gas barrier coating can be in contact with one primary surface of the paper substate directly or optionally through a primer layer or a prepainted layer. The optional primer layer may be applied on one primary surface of the paper substate, so that the primer layer resides between the gas barrier coating and the paper substrate.

The gas barrier laminate of the present invention may further comprise or be frec of a primer layer residing between the gas barrier coating and the paper substrate. The primer layer may be used to improve barrier coating holdout of the paper substrate, thus further improving barrier properties of the resulting laminate. The primer layer may be formed from an aqueous primer composition, e.g., by drying the aqueous primer composition under conditions as described above for drying the aqueous gas barrier composition. The aqueous primer composition may comprise one or more emulsion polymers selected from an acrylic (co)polymer such as ethylene-acrylic acid copolymer, styrene butadiene copolymer, polyolefins such as polyethylene, or combinations thereof. “Acrylic (co)polymer” as used includes a homopolymer of an acrylic monomer, a copolymer of an acrylic monomer with a different acrylic monomer or other monomers such as styrene, or mixtures thereof. “Acrylic monomer” as used may include, for example, (meth)acrylic acid, alkyl (meth)acrylate, (meth)acrylamide, (meth)acrylonitrile and their modified forms such as hydroxyalkyl (meth)acrylate. The aqueous primer composition may also comprise one more pigment and/or extender as described above in the aqueous gas barrier composition section. If present, the primer layer may generally have a thickness in a range of from 0.2 μm to 6 μm, and can be 0.2 μm or more, 0.5 μm or more, or even I μm or more, while at the same time is generally 6 μm or less, and can be 5 μm or less, 4 μm or less, or even 3 μm or less.

The gas barrier laminate of the present invention may further comprise one or more functional layers. For example, the multilayer article may further comprise a functional layer, so that the functional layer resides between the gas barrier coating and the paper substrate or resides on top of the gas barrier coating. The presence of the functional layer may be useful to further improve the smoothness of the paper substrate and barrier performance of the gas barrier laminate.

The paper substrate useful in the present invention can be any types of paper, particularly those suitable for food packaging. The paper substrate can be precoated on one or both primary surfaces of the paper substrate, e.g., primed surfaces or painted surfaces, prior to applying the aqueous gas barrier composition. Suitable paper materials include, for example, freeshect paper (e.g., coated or uncoated freeshect), uncorrugated or corrugated paperboard, newsprint paper, Kraft paper, and pan liner paper stock. The paper materials may have various basis weight and can be in a range of from 30 to 100 grams per square meter (g/m²), and can be from 40 to 95 g/m², from 50 to 90 g/m², or from 60 to 80 g/m², as measured according to ISO 536. The paper substrate typically has a thickness in a range of from 30 to 100 μm, and can be 40 μm or more, 50 μm or more, or even 60 μm or more, while at the same time is generally 100 μm or less, 95 μm or less, 90 μm or less, or even 85 μm or less. Suitable commercially available paper materials may include UPM Brilliant™ Pro paper available from UPM Company.

The present invention also relates to a process for preparing the gas barrier laminate, comprising: (1) providing the paper substrate, (ii) applying the aqueous gas barrier composition to the paper substrate, and (iii) drying the aqueous gas barrier composition at a temperature of less than 120° C. for less than 10 minutes to form the gas barrier coating; thereby obtaining the gas barrier laminate. The process for preparing the gas barrier laminate may further comprise: applying the aqueous primer composition to the paper substrate to form a primer layer before applying the gas barrier composition to the paper substrate.

In the process for preparing the gas barrier laminate, the aqueous gas barrier composition can be applied to the paper substrate by any known methods, for example, coating the aqueous gas barrier composition to at least one primary surface of the paper substrate by incumbent means including blade coating, rod coating, curtain coating, size press, gravure, brushing, dipping, rolling, spraying, and bar coating

In the process for preparing the gas barrier laminate, drying the aqueous gas barrier composition can be conducted under mild conditions, for example, at temperatures of less than 120° C., for a short period of time, e.g., less than 10 minutes. Drying temperatures can be less than 120° C., and can be 115° C. or less, 110° C. or less, 105° C. or less, 100° C. or less, and can be less than 100° C., while at the same time is generally 40° C. or more, 50° C. or more, 60° C. or more, 70° C. or more, 80° C. or more, 90° C. or more, or even 95° C. or more. Preferably, drying the aqueous gas barrier composition is carried out at 60° C. to 100° C. Drying time can be less than 10 minutes (min), and can be 9 min or less, 8 min or less, 7 min or less, 6 min or less, 5 min or less, 4 min or less, 3 min or less, or even 2 min or less. Drying the aqueous gas barrier composition forms the gas barrier coating, which does not require further heat treatment under high temperatures, e.g., 120° C. or higher, 130° C. or higher, 140° C. or higher, 150° C. or higher, 160° C. or higher, 170° C. or higher, 180° C. or higher, 190° C. or higher, or even 200° C. or higher.

The process for preparing the gas barrier laminate is carried out through a simple, convenient, and inexpensive process as compared with incumbent processes requiring heat treatment at high temperature (e.g., 120° C. or higher). The process for preparing the gas barrier laminate can be carried out under mild conditions (e.g., at low temperatures for a short period of time described below under drying the aqueous gas barrier composition section), but also can be free of the step of further heat treatment of the gas barrier laminate under the high temperatures described above, which enable easy processability, quick processing, and energy saving while still offering excellent gas barrier and foldability properties.

The process for preparing the gas barrier laminate may further comprise the step of forming the gas barrier laminate into a shaped article by known means such as folding, gluing, pressure-forming and twisting, and particularly, by folding. Due to the good foldability of the gas laminate, forming the gas barrier laminate into the shaped article can comprise folding the gas barrier laminate into various shapes without significantly compromising gas barrier properties. Desirably, the shaped article (i.e., the gas barrier laminate after folding) can provide an OTR of 4.0 cubic centimeter per square meter per day (cc/m²·day) or less, 3.9 cc/m2·day or less, 3.8 cc/m²·day or less, 3.7 cc/m²·day or less, or even 3.5 cc/m²·day or less, as measured according to ASTM D3985-05 using a MOCON Ox-Tran Model 2/21 at 23° C. and 50% relative humidity (RH) (further details provided under Foldability Characterization).

The gas barrier laminate of the present invention or prepared by the process described above is excellent in gas barrier property against oxygen as indicated by an OTR of 1.0 cc/m²·day or less, and preferably 0.1 cc/m²·day or less. Determine OTR according to ASTM D3985-05 using a MOCON Ox-Tran Model 2/21 at 23° C. and 50% RH (further details provided below under OTR Characterization). The gas barrier laminate may have an OTR of 1.0 cc/m²·day or less, and can be 0.8 cc/m²·day or less, 0.5 cc/m²·day or less, or even 0 1 cc/m²·day or less. At the same time, the gas barrier laminate has good foldability as indicated by a folded OTR of 4.5 cc/m²·day or less, and preferably, 1.1 cc/m²·day or less, as measured according to ASTM D3985-05 using a MOCON Ox-Tran Model 2/21 at 23° C. and 50% RH (further details provided under Foldability Characterization) The gas barrier laminate can provide a folded OTR of 4.5 cc/m²·day or less, and can be 4.0 cc/m²·day or less, 3.7 cc/m²·day or less, 3.5 cc/m²·day or less, 3.0 cc/m²·day or less, 2.5 cc/m²·day or less, 2.0 cc/m²·day or less, 1.8 cc/m²·day or less, 1.5 cc/m²·day or less, 1.2 cc/m²·day or less, 1.1 cc/m²·day or less, 1.0 cc/m²·day or less, 0.90 cc/m²·day or less, 0.80 cc/m²·day or less, 0.50 cc/m²·day or less, 0.30 cc/m²·day or less, 0.28 cc/m²·day or less, or even 0.1 cc/m²·day or less. A folded OTR is useful characteristic as a measure of foldability. For food packaging applications, foldability is a significant performance index that determines the shelf life of food, which makes the packaging be transformed into different kinds of shapes during transportation and suitable for different food packaging applications where various shaped are needed. Having such a good barrier property and by being easily foldable makes the gas barrier laminate particularly useful to form a shaped article of any size or shape that is suitable for food packaging applications. The gas barrier laminate may be formed into a shaped article by known means such as folding, gluing, pressure-forming, and particularly, by folding. The gas barrier laminate is suitable for use in various applications such as food packaging, medicine packaging, personal care packaging. The gas barrier laminate is particularly suitable for food packaging applications such as food containers such as boxes for fast food, food receptacles such as paper plates, and food wrappers such as wrapping materials for hamburgers, sandwiches, candies, chocolates, and snacks. The present invention also relates to a food packaging comprising the gas barrier laminate.

### EXAMPLES

Some embodiments of the invention will now be described in the following Examples. Materials for use in preparing samples, and standard analytical equipment and methods for use in the Examples and in determining the properties and characteristics are described herein below:

EXCEVAL™ RS-2117, available from Kuraray Company (Japan), is an ethylene modified polyvinyl alcohol (“EVOH”), which is hydrophobically modified polyvinyl alcohol powder (degree of hydrolysis=98-99 mol %, pH=5.0-7.0, Mw=80,000 g/mol, ethylene content=1-4 mol %).

PVA 17-99, available from Sinopharm Company, is polyvinyl alcohol (“PVOH”) powder (degree of hydrolysis=99 mol %, pH=5.0-6.5, and Mw=80,000 g/mol).

ACUMER™ 1510 polymer, available from The Dow Chemical Company, is an aqueous solution of polyacrylic acid homopolymer (“PAA”) (solids content=24-26 wt %, pH=1-2.1, number average molecular weight (Mn)=20, 100 g/mol, and Mw=66,600 g/mol).

Sodium hydroxide (NaOH) is available from Sinopharm Chemical Reagent Co., Ltd.

UPM Brilliant™ Pro paper substrate, available from UPM Company, has a basis weight of 60 g/m² and a thickness of 50-60 μm (Gurley porosity=23,000 seconds, paper print-surf roughness (PPS)=1.6).

### GPC Analysis for (Meth)acrylic Acid Polymer

Samples were prepared at a concentration of 1 milligram per milliliter (mg/mL) in 20 millimoles (mM) NaH₂PO₄ at pH=7. The polymer solutions were filtered using 0.2 μm polyvinylidene fluoride (PVDF) filters into autosampler vials. Size Exclusion Chromatography (SEC) separations were carried out on Polymer Separations' Alliance 2690 SEC system consisting of an isocratic pump, degasser, autosampler, and refractive index (RI) detector operated at 40° C. SEC separations were performed on two TSKgel columns (300×7.8 millimeters ID each), pore size labeled as GMPWXL and G2500PWXL, particle size 13 and 6 μm in NaH₂PO₄/Na₂HPO₄ at pH=7. Then 100 microliters (mL) of the sample solution were injected into the column set. Mn and Mw were determined using Broad Hamielic Calibration approach based on a polyacrylic acid standard with known molecular weight.

### Measurement of Molecular Weight of EVOH

The molecular weight was determined according to the following steps (A) and (B):
(A) Determination of average degree of polymerization of EVOH (“P_{A}”)
   1. Sample pre-treatment:

(1-a) Add 10 grams (g) of a sample into a conical flask with 200 mL methanol, followed by addition of 12.5 mol/L sodium hydroxide (NaOH) solution, with stirring. The loading of the NaOH solution used was 3 mL for the sample with a saponification degree >97% and 10 mL for the sample with a saponification degree below 97%.

(1-b) After stirring, heat the mixture obtained from step (1-a) at 40±2° C. for 1 hour until the residual acetate group in the sample was completely dissolved.

(1-c) Add a phenolphthalein solution, wash with methanol to remove NaOH and sodium acetate, and then transfer to a watch glass and dry at 105±2° C. for 1 hour until no methanol remained.

### 2. Viscosity Measurement

(2-a) Add 1 g of the sample obtained from step (1-c) above into 100 mL water to dissolve, and then cool the resulting liquid to room temperature, followed by filtering with a sintered glass filter or filter paper.

(2-b) Use a pipette to transfer 10 mL of the liquid obtained from step (2-a) to an Ostwald viscometer, and calculate the relative viscosity of the test liquid at 30.0±0.1° C. in comparison of viscosity of water at the same temperature.

### 3. Concentration Measurement

(3-a) Put the pre-washed evaporating dish into an oven at 105° C. for more than 1 hour, and then cool it to room temperature in a desiccator.

(3-b) Use a pipette to transfer 20 mL filtrate obtained from step (2-a) above to an evaporating dish. After evaporating, dry the resulting sample in an oven at 105° C. for more than 4 hours and place it in a desiccator to cool to room temperature.

### 4. Calculation of Average Degree of Polymerization

The average degree of polymerization, P_{A}, is calculated by the following equation (II):

$$Log {P}_{A} = 1.613 log ( [ η ] * 104 / 8.29 ) \qquad ( II )$$

where [η]=(2.303*log ηᵣₑᵢ)/C; ηᵣₑᵢ=t₁/t₀, and C=1000*(W₂−W₃)/V;
where [η] refers to limiting viscosity, ηᵣₑᵢ refers to relative viscosity, t₁ refers to falling time for the test liquid (second), t₀ refers to falling time for water (second), C refers to concentration of tested sample (g/L), W₂ refers to the quality of dried sample and evaporating dish (g), W₃ refers to the quality of evaporating dish (g), and V refers to the volume of filtrate (mL).
   (B) Determination of Molecular Weight The molecular weight is calculated according to the following cquation (III):

$$Molecular weight = 42 * {P}_{A} \qquad ( III )$$

where P_{A} is the average degree of polymerization obtained from the equation (II) above.

### Measurement of Saponification Degree of EVOH

The saponification degree of EVOH was determined as follows:

(a) Place a sample in a conical flask according to the estimated saponification degree and sampling amount as specified in Table A and weigh to the nearest 1 mg.

(b) Add 100 mL of water and 3 drops of a phenolphthalein solution, then heat to over 90° C. with stirring to dissolve the sample completely.

(c) After cooling to room temperature, add 20 mL 0.1 mL/L sodium hydroxide solution with a burette according to Table A, stir and mix thoroughly, and leave it at room temperature for more than 2 hours.

(d) Use a burette to add sodium hydroxide solution and 25 mL sulfuric acid or hydrochloric acid at the same concentration into the conical flask, and shake well.

(e) According to Table A, titrate the resultant solution with 0.1 mol/L or 0.5 mol/L sodium hydroxide solution until the color turns reddish.

(f) As a blank test, run steps (b)-(e) without adding a sample.

The saponification degree (mol %), denoted as “H”, is calculated using the equation (IV) below:

$$H = 100 - {X}_{2} \qquad ( IV )$$

where X₁=[(a−b)*f*D*0.06005/(S*P/100)]*100, and X₂=44.05*X₁/(60.05−0.42*X₁);
where X;: acetic acid content equivalent to residual acetate (%),
X₂: residual acetate (mol %),
a: the amount of sodium hydroxide solution (ml) (0.1 mol/L or 0.5 mol/L),
b: the amount of sodium hydroxide solution (0.1 mol/L or 0.5 mol/L) used in the blank test (mL),
f: coefficient of sodium hydroxide standard solution,
D: concentration of prescribed liquid (0.1 mol/L or 0.5 mol/L),
S: sample amount (g),
P: sample concentration (%).

TABLE A
Estimated saponification degree sampling
amount and prescribed liquid

| | | Prescribed liquid | |
|---|---|---|---|
| Estimated saponification | Sample | Concentration | Volume |
| degree (mol %) | amount (g) | (mol/L) | (mL) |
| >97 | 3 | 0.1 | 25.00 |
| 90-97 | 3 | 0.5 | 25.00 |
| 80-90 | 2 | 0.5 | 25.00 |
| 70-80 | 1 | 0.5 | 25.00 |

### Preparation of PVOH Solution

Ten (10) parts of PVA 17-99 were dissolved in 90 parts of deionized (DI) water by stirring at 90° C. for 3 hours to give a clear solution of PVOH with a solids content of 10 wt %, which was then cooled to room temperature.

### Preparation of EVOH Solution

Ten (10) parts of RS-2117 were dissolved in 90 parts of DI water by stirring at 90° C. for 3 hours to give a clear solution of EVOH with a solids content of 10 wt %, which was then cooled to room temperature.

### Preparation of NaOH Solution

Ten (10) parts of NaOH were dissolved in 90 parts of DI water by stirring at room temperature for 15 min to give a clear solution of NaOH with a solids content of 10 wt %.

### Preparation of Neutralized PAA Solution

Calculated amounts of NaOH solution prepared above with regard to the number of moles of carboxyl groups in PAA were mixed with an aqueous solution of PAA to obtain partially neutralized PAA products (“PAA (Na)”) having degrees of neutralization of 5 mol %, 10 mol %, 15 mol %, 20 mol %, 25 mol % and 50 mol %, respectively. Formulations of raw materials used and properties of the resulting neutralized PAA are given in Table 1.

TABLE 1
Neutralized PAA Solution

| | Raw Material | | Characterization of Neutralized PAA Solution | | | |
|---|---|---|---|---|---|---|
| | ACUMER 1510 | NaOH | Neutralization | Final solids | | |
| | (25%), gram | (10%), gram | degree¹ | content² | pH | Viscosity³ |
| PAA(Na)-05 | 50 | 3.46 | 5 mol % | 23.75% | 3.72 | 108 cp |
| PAA(Na)-10 | 50 | 6.93 | 10 mol % | 22.65% | 4.29 | 142 cp |
| PAA(Na)-15 | 50 | 10.41 | 15 mol % | 21.68% | 4.55 | 196 cp |
| PAA(Na)-20 | 50 | 13.88 | 20 mol % | 20.82% | 5.01 | 192 cp |
| PAA(Na)-25 | 50 | 17.35 | 25 mol % | 20.04% | 5.18 | 158 cp |
| PAA(Na)-50 | 50 | 34.70 | 50 mol % | 17.11% | 5.34 | 126 cp |

¹Neutralization degree was calculated by the equation (I) described above.
²Final solids content (wt % relative to Neutralized PAA Solution weight) was based on calculations, e.g., the final solids content of “PAA(Na)-05” was calculated by (50*0.25 + 3.46*0.1*23/40)/(50 + 3.46) = 23.75%.
³Viscosity was measured using a Brookfield Ametek DV2TLVTJ0 (LV #3, 100 RPM) at room temperature (23 ± 2° C.).

### Gas Barrier Laminate Samples IEs 1-8 and CEs 1.9

The EVOH Solutions prepared above were mixed with the Neutralized PAA Solutions prepared above (with different neutralization degrees) to obtain aqueous mixture solution samples with final solids contents of 10 wt %, based on formulations given in Table 2. These aqueous mixture solutions (also as “gas barrier compositions”) were bar-coated onto UPM Brilliant Pro paper (basis weight: 62 g/m², thickness: 50-55 μm) as the substrate using a Meyer bar automatic film-coating apparatus, and 15 then dried at 100° C. for 2 min with a dry film thickness controlled at 10±2 μm.

### Gas Barrier Laminate Sample IE 9

The EVOH Solution prepared above was mixed with the Neutralized PAA solution with a degree of neutralization of 10 mol % (i.e., PAA(Na)-10) at a weight ratio of EVOH/Neutralized PAA of 60:40 by solids weight to obtain an aqueous mixture solution sample with a final solids content of 10 wt %. The aqueous mixture solution (also as “gas barrier composition”) was bar-coated onto UPM Brilliant Pro paper (basis weight: 62 g/m², thickness: 50-55 μm) as the substrate using a Meyer bar automatic film-coating apparatus, and then dried at 60° C. for 2 min with a dry film thickness controlled at 10±2 μm.

### Gas Barrier Laminate Sample CE 10

The PVOH Solution prepared above was mixed with the PAA(Na)-10 prepared above (i.e., a solution of neutralized PAA with a degree of neutralization of 10 mol %) at a ratio of PVA 17-99/PAA(Na)-10 by solids weight of 80/20. The resulting mixture solution was bar-coated onto UPM Brilliant Pro paper (basis weight: 62 g/m²) as the substrate using a Meyer bar automatic film-coating apparatus, and then dried at 100° C. for 2 min with a dry film thickness controlled at 10±2 μm.

The above obtained laminate samples were characterized for oxygen transmission rate and/or foldability properties on paper substrates according to the test methods described below:

### Oxygen Transmission Rate Characterization

The oxygen transmission rate (“OTR”) for a laminate sample was measured according to ASTM D3985-05 using a MOCON Ox-Tran Model 2/21 at 23° C. and 50% RH.

### Foldability Characterization

A laminate sample was first folded in half and put a 500 g weight was put on the folded sample for 15 min. The weight was then removed and the folded sample was further folded perpendicular to the first fold to create four quadrants, and a 500 g weight was put on the resulting cross-folded sample for another 15 min.

The cross-folded sample was then evaluated for an OTR (denoted as “Folded OTR”) according to ASTM D3985-05 using a MOCON Ox-Tran Model 2/21 (upper detection limit: 100 cc/m²·day) at 23° C. and 50% RH. A sample with a folded OTR of 4.5 cc/m²·day or less has good foldability. Otherwise, a sample with a folded OTR of greater than 4.5 cc/m²·day has poor foldability.

Notably, some samples had OTR values too high that could not be detected under the above testing conditions (i.e., outside the upper detection limit of 100 cc/m²·day) so they are reported as having an OTR or folded OTR value of >100 cc/m²·day.

Table 2 gives characterization results of some of the above laminates. As shown in Table 2, as compared to samples comprising EVOH while no neutralized PAA. 80 wt % and 100 wt % of neutralized PAAs, respectively (CE 1, CE 9 and CE 5), CEs 2-4 laminate samples comprising neutralized PAAs at concentrations of 10 wt %, 60 wt %, and 70 wt %, respectively, demonstrated better gas barrier properties, but provided poor foldability (e.g., folded OTRs for CEs 2-4 were much higher than 50% of the folded OTR of CE 1). CEs 6-8 laminate samples comprising a mixture of EVOH with non-neutralized PAA or neutralized PAAs with degree of neutralization of 5 mol % and 20 mol %, respectively, all failed to meet the foldability requirement. Surprisingly, IE 1 to IE 8 laminate samples all demonstrated good gas barrier properties with low OTRs (e.g., 1.0 cc/m²·day or lower at 23° C. and 50% RH), and good foldability (e.g., folded OTRs decreased by more than 50% of that of CE 1 or CE 5 laminate sample). Particularly, IEs 2-6 and 8 laminate samples demonstrated excellent foldability, as the samples after cross-folding still achieved folded OTRs close to or even lower than 1 cc/m²·day at 23° C. and 50% RH. Moreover, IE 9 laminate sample prepared by drying at 60° C. showed an OTR (23° C., 50% RH) of 0.072 cc/m²·day.

In contrast, CE 10 laminate sample comprising PVOH and neutralized PAA in the gas barrier coating provided an acceptable OTR (23° C. 50% RH) of 0.026 cc/m²·day, but demonstrated poor foldability as indicated by a folded OTR (23° C., 50% RH)>100 cc/m²·day.

TABLE 2
Formulations and characterization of gas barrier laminate with UPM paper substrate

| Sample | CE 1 | CE2 | IE 1 | IE 2 | IE 3 | IE 4 | IE 5 | IE 6 | IE 7 |
|---|---|---|---|---|---|---|---|---|---|
| Component, gram | | | | | | | | | |
| EVOH solution | 10.00 | 10.00 | 10.00 | 10.00 | 10.00 | 10,00 | 10.00 | 10.00 | 10.00 |
| (10%) | | | | | | | | | |
| PAA(Na)-10 | | 0.51 | 1.14 | 1.52 | 1.95 | 2.45 | 3.04 | 3.73 | 4.56 |
| PAA | | | | | | | | | |
| PAA(Na)-05 | | | | | | | | | |
| PAA(Na)-15 | | | | | | | | | |
| PAA(Na)-20 | | | | | | | | | |
| Characterization | | | | | | | | | |
| Wt % PAA(Na) | 0 | 10% | 20% | 25% | 30% | 35% | 40% | 45% | 50% |
| OTR (23° C., 50% | 2.0 | 0.049 | 0.037 | 0.025 | 0.058 | 0.078 | 0.17 | 0.092 | 0.065 |
| RH), cc/m² · day | | | | | | | | | |
| Foldability - | ≥9 | 5.76 | 3.7 | 1.01 | 0.28 | 0.04 | 0.27 | 0.82 | 2.98 |
| Folded OTR | | | | | | | | | |
| (23° C., 50% | | | | | | | | | |
| RH), cc/m² · day | | | | | | | | | |

| Sample | CE 3 | CE4 | CE9 | CE5 | CE 6 | CE 7 | IE 8 | CE 8 |
|---|---|---|---|---|---|---|---|---|
| Component, gram | | | | | | | | |
| EVOH solution | 10.00 | 10.00 | 10.00 | 10.00 | 10.00 | 10.00 | 10.00 | 10.00 |
| (10%) | | | | | | | | |
| PAA(Na)-10 | 6.83 | 10.63 | 18.22 | 10.00 | | | | |
| PAA | | | | | 2.15 | | | |
| PAA(Na)-05 | | | | | | 2.3 | | |
| PAA(Na)-15 | | | | | | | 2.6 | |
| PAA(Na)-20 | | | | | | | | 2.75 |
| Characterization | | | | | | | | |
| Wt % PAA(Na) | 60% | 70% | 80% | 100% | 35% | 35% | 35% | 35% |
| OTR (23° C., 50% | 0.13 | 0.26 | >100 | >100 | 0.547 | 0.12 | 0.076 | 0.11 |
| RH), cc/m² · day | | | | | | | | |
| Foldability - | >100 | >100 | >100 | >100 | 6.02 | 5.07 | 0.36 | 4.75 |
| Folded OTR | | | | | | | | |
| (23° C., 50% | | | | | | | | |
| RH), cc/m² · day | | | | | | | | |

“Wt % PAA(Na)” refers to weight percentage of partially neutralized PAA relative to the weight of a mixture of EVOH and partially neutralized PAA, both by solids weight.

1. A process for preparing a gas barrier laminate, comprising:
(i) providing a paper substrate,
(ii) applying an aqueous gas barrier composition to the paper substrate, wherein the aqueous gas barrier composition comprises:
(a) an ethylene-vinyl alcohol copolymer having a saponification degree of 85 mol % or more, and
(b) a partially neutralized (meth)acrylic acid polymer having a degree of neutralization of from 6 mol % to 18 mol %;
wherein the weight ratio of the ethylene-vinyl alcohol copolymer to the partially neutralized (meth)acrylic acid polymer is in a range of from 80:20 to 50:50; and
(iii) drying the aqueous gas barrier composition at a temperature of less than 120° C. for less than 10 minutes to form a gas barrier coating; thereby obtaining the gas barrier laminate.

2. The process of claim 1, wherein the weight ratio of the ethylene-vinyl alcohol copolymer to the partially neutralized (meth)acrylic acid polymer is in a range of from 75:25 to 62:38.

3. The process of claim 1, wherein the partially neutralized (meth)acrylic acid polymer has a degree of neutralization of from 10 mol % to 15 mol %.

4. The process of claim 1, wherein drying the aqueous gas barrier composition is carried out at a temperature of from 60° C. to 100° C.

5. The process of claim 1, wherein the (meth)acrylic acid polymer is selected from polyacrylic acids; polymethacrylic acids; copolymers of acrylic acid and methacrylic acid; copolymers of (meth)acrylic acid, maleic acid and/or maleic anhydride, and optionally (meth)acryl amide; or mixtures thereof.

6. The process of claim 1, wherein the process is free of the step of further heat treatment of the gas barrier laminate at a temperature of 120° C. or higher.

7. The process of claim 1, wherein prior to step (ii), the paper substrate is coated with a primer layer so that the primer layer resides between the substrate and the gas barrier coating.

8. The process of claim 1, wherein the gas barrier coating has a dry weight of less than 15% of the weight of the paper substrate.

9. The process of claim 1, further comprising the step of folding the gas barrier laminate into a shaped article.

10. The process of claim 1, wherein the ethylene-vinyl alcohol copolymer has an ethylene content of 10 mol % or less.

11. A gas barrier laminate comprising a paper substrate and a gas barrier coating residing on the paper substrate, wherein the gas barrier coating is formed from an aqueous gas barrier composition comprising:
(a) an ethylene-vinyl alcohol copolymer having a saponification degree of 85 mol % or more, and
(b) a partially neutralized (meth)acrylic acid polymer having a degree of neutralization of from 6 mol % to 18 mol %;
wherein the weight ratio of the ethylene-vinyl alcohol copolymer to the partially neutralized (meth)acrylic acid polymer is in a range of from 80:20 to 50:50.

12. A food packaging comprising the gas barrier laminate of claim 11.
